(19) United States
(12) Patent Application Publication
(10) Pub. No.: US 2025/0035141 A1
(43) Pub. Date: Jan. 30, 2025

(54) TELESCOPING APPARATUS

(71) Applicant: James R. Conrad, Salinas, CA (US)

(72) Inventor: James R. Conrad, Salinas, CA (US)

(21) Appl. No.: 18/445,353

(22) Filed: Jul. 25, 2023

(51) Int. Cl. F16B 7/14; B25G 1/04

(52) U.S. Cl. CPC F16B 7/1454; B25G 1/04

(57) ABSTRACT

A telescoping apparatus with carbon tubes including decagon shaped tubes for preventing the telescoping apparatus from internal twisting while providing enhanced strength and grip, the apparatus is useful for cleaning swimming pools, cement finishing tools, and ceiling wire applications. The apparatus includes three tubes with two locking assemblies with locking collars having a receiving cradle for quick release locking mechanisms with relief channels and ten separate surfaces to compress on the decagon shaped tubes.

### BACKGROUND OF THE INVENTION

### Technical Field

This invention relates to apparatuses or devices for cleaning swimming pools, surface cleaning tools, cement finishing tools, ceiling wire tools and the like, and more particularly to an apparatus using telescopic or expandable carbon poles with locking collars and quick release mechanisms for attachment to tools for cleaning swimming pools, surface cleaning tools, cement finishing tools, ceiling wire apparatus, and other objects.

### BACKGROUND ART

Various devices have been proposed and implemented for holding and positioning tools and other articles using telescopic poles. Such devices allow a user to both grip the tool and increase extension, reach, and leverage. Many examples of such prior extendable handles for tools and other implements exist and include, extendable handles for shovels, brushes, hammers, screwdrivers, mops, rakes, and the like. Although prior devices have been adapted and used for such various purposes, there exists a need for a telescopic pole or handle for swimming pool cleaning devices which can be used for positioning and securing a cleaning tool securely even under high pressure, twisting and tension which arises from strongly pushing or pulling the tool through water or other applications.

Telescoping or extendable handles are very useful for swimming pool cleaning tools so that the user can clean the pool without getting wet while standing or walking along the side of the pool. Similar extendable handle tools are used for painting, window washing, and concrete and paving operations.

Examples of extendable handles or telescoping poles are those with two separate lengths of tubing, configured so that one slides within the other to adjust the overall length of the pole, and a positioning or locking device so that when locked, the the two lengths do not move or slide with respect to one another.

Such extendable handle or telescoping poles are typically composed of aluminum, fiberglass or other strong, durable material. A plurality of apertures are positioned so that a pin or other fastening means can be inserted often via a collar type mechanism and thereby position the tubes at varying lengths in relation to each other as desired.

Other telescoping poles use external locking devices, compression rings, or sliding lock assemblies for retaining and positioning the tubes relative to one another. Other examples include internal and external locking devices, multiple locking mechanisms and the use of three tubes.

Such prior telescoping or extendable poles, however, have serious limitations which have limited there usefulness, especially in the application to swimming pool tools and cleaning devices. One such limitation is that the locking mechanisms often weaken or loosen, resulting in collapse or slippage when pressure is applied during use.

Further such prior poles are prone to internal twisting, and bending and weakening of the locking means which are subject to wear and tear over time. This results in deformation and sliding of the inner tube within the outer tube. And may result in jamming or the inability of the inner tube to properly slide and be aligned within the outer tube. Or if the locking and position means fail the inner tube may be overextended and completely separate from the inner tube. Prior poles typically used a series of bolt holes drilled into the inside pole which met with a pin located in a handle assembly that is controlled by spring pressure which forces the pin into a hole and stays in place while forward and backward movement is applied. The major problem with this prior mechanism was that the pivot hole or bolt hole located in the handle has to be above the location of the drilled holes in the inside tube. By locating this pin hole above the tube, this creates an alignment which favors the pin to pull up an out of the hole, resulting in pole failure and collapse.

Further limitations of prior devices are seen with grips that fail to secure tightly to the inner tube allowing slippage of the inner tube if that tube slides too far within the outer tube. This may require repositioning or reassembly of the pole again prior to use. Prior telescopic pole assemblies, such as Conrad, U.S. Pat. No. 11,333,182 improved on existing telescopic assemblies but differ significantly from the present invention.

The present invention provides an improved telescoping or extendable pole for swimming pool cleaning and maintenance tools, cement finishing tools, ceiling wire applications, and the like, which overcomes the defects of prior telescoping or extendable poles and handles. The present invention provides a reliable, stable, and easy to use and operate telescoping pole or handle for swimming pool cleaning and maintenance tool, and other tools using extendable handles. The improved telescoping or extendable pole of the present invention comprises an three interconnecting tubes, a first tube, an inner tube, and an end tube, which may be round, decagon, dodecagon or otherwise and includes two locking assemblies.

Another object of the present invention, is to provide a carbon fiber telescoping or extendable apparatus for cleaning swimming pools and the like, in which two locking assemblies hold three pole sections together and securely maintains the integrity of the extended length of the pole under all conditions of use. By using decagon shaped tubes this prevents the telescoping apparatus from internal twisting and slippage while providing enhanced strength and grip.

A primary object object of the present invention is to provide a telescoping apparatus for pool cleaning tools and the like, that includes a first tube having a first end and a second end, the second end having a first locking assembly; the first tube having a decagon shaped interior surface, and the first end of the first tube being configured for attaching a tool thereto. The first locking assembly includes a locking collar having a receiving cradle for a first quick release locking and positioning mechanism, and one or more relief channels on the interior of the locking collar for increased locking strength of the collar. A decagon shaped end tube is provided having a first end and a second end, with the first end having a second locking assembly The second locking assembly includes a locking collar having a receiving cradle for a second quick release locking and positioning mechanism, and one or more relief channels on the interior of the locking collar for increased locking strength of the collar: The end tube has an inner decagon shaped surface and an outer decagon shaped surface, and a second end with a clip mechanism and a stop ring mechanism for securing a removable hand grip thereto and to prevent unwanted movement of the hand grip. The apparatus of the present invention also includes a decagon shaped inner tube having a first end and a second end. The first end being secured to the first tube by the first locking assembly, and the second end being secured to the end tube by said second locking assembly. The decagon shaped inner tube is adapted and configured to be received within the end tube and the decagon shaped inner tube is shaped to slide within the end tube to a selected position in relation to the end tube. This allows for the second locking assembly to position and secure the decagon shaped inner tube within the end tube by the second locking assembly.

Yet another object of the present invention is to provide a lightweight telescoping apparatus for pool cleaning tools and the like, that includes a grooved grip that is detachably secured to the end tube at an end thereof.

Accordingly, the present invention provides a telescoping apparatus or expandable pole for swimming pool cleaning tools, that is very stable and secure under high pressure and stress, prevents internal twisting while providing enhanced strength and grip, and is easy to assemble or disassemble, and may be used with a wide variety of pool cleaning tools, and other tools as desired.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### SUMMARY OF THE INVENTION

To achieve the foregoing objects, and in accordance with the purpose of the invention as embodied and broadly described herein, preferably a plurality of carbon fiber tubes and quick release locking mechanisms and collar, provide a telescoping apparatus for cleaning swimming pools, cement finishing tools, ceiling wire applications and the like comprises a telescoping apparatus including decagon shaped tubes for preventing the telescoping apparatus from internal twisting while providing enhanced strength and grip. Preferably, a first tube having a first end and a second end is provided, the second end having a first locking assembly and a decagon shaped interior surface. The first end of the first tube is configured for attaching a tool thereto and may include a material sleeve and V-shape clip or bolt. The first locking assembly includes a locking collar having a receiving cradle for a first quick release locking and positioning mechanism, and one or more relief channels on the interior of the locking collar for increased locking strength of the collar. A decagon shaped end tube with a first end and a second end is provided, with the first end including a second locking assembly with a locking collar. The locking collar of the second locking assembly includes a receiving cradle for a second quick release locking and positioning mechanism, and one or more relief channels on the interior of the locking collar for increased locking strength of the collar. The end tube has an inner decagon shaped surface and an outer decagon shaped surface, and a second end with a clip mechanism and a stop ring mechanism for securing a removable hand grip thereto and to prevent unwanted movement of the hand grip. A decagon shaped inner tube has a first end and a second end, with the first end being secured to the first tube by the first locking assembly, and the second end being secured to the end tube by the second locking assembly. The decagon shaped inner tube is adapted and configured to receive end tube therein and accordingly has a larger diameter. And the end tube is configured and shaped to slide within the inner tube to a selected position in relation to the end tube, allowing for the second locking assembly to position and secure the decagon shaped inner tube within the end tube by the second locking assembly.

Preferably, the locking collar of the first locking assembly has a receiving cradle for a first quick release locking and positioning mechanism, and ten relief channels on the interior of the locking collar for increased locking strength of the collar, and ten separate flat surfaces to compress to each of the ten surface of the decagon shaped inner tube. The locking collar of the second locking assembly has a receiving cradle for a first quick release locking and positioning mechanism, and ten relief channels on the interior of the locking collar for increased locking strength of the collar, and ten separate flat surfaces to compress to each of the ten surface of the decagon shaped end tube.

### BRIEF DESCRIPTION OF DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 shows a telescoping apparatus for swimming pool tools and the like, with a cleaning tool attached, according to the invention.

FIG. 2 shows a telescoping apparatus for swimming pool tools and the like, here shown without a tool attached, according to the invention.

FIG. 3 shows the locking collar of the first locking assembly, according to the invention.

FIG. 4 shows the receiving cradle, relief channels, and lever arm of the first locking assembly, according to the invention.

FIG. 5 shows the locking collar, quick release lever, and fastening mechanism of the first locking assembly, according to the invention.

FIG. 6 shows the locking collar of the second locking assembly, according to the invention.

FIG. 7 shows the receiving cradle, relief channels, and lever arm of the second locking assembly, according to the invention.

FIG. 8 shows the locking collar, quick release lever, and fastening mechanism of the second locking assembly according to the invention.

FIG. 9 shows the grip of the telescoping assembly, with slits and tapered threads, according to the invention.

FIG. 10 shows the end tube, with and internal stop ring and a stop ring for the grip, according the invention.

FIG. 11 shows the V-shape clip with buttons for securing the grip on the end tube, and the sleeve on the first tube, according to one embodiment of the invention.

FIG. 12 shows the sleeve which is secured to the first tube, according to one embodiment of the invention.

FIG. 13 shows a magnet and magnet housing, for attachment to the telescoping apparatus, according to one embodiment of the invention.

FIG. 14 shows the first tube, the inner tube, and end tube alone, and separated from one another without the locking assemblies, grip, or tool attached, to according to one embodiment of the invention.

FIG. 15 shows a grip detached from the telescoping apparatus, according to one embodiment of the invention.

FIG. 16 shows the sleeve preferably secured to the first tube, according to one embodiment of the invention.

FIG. 17 shows a lever detached from the locking assemblies for illustrative purposes, according to one embodiment of the invention.

FIG. 18 shows the locking collar of the second locking assembly, according to one embodiment of the invention.

FIG. 19, shows the locking collar of the first locking assembly, according to one embodiment the invention.

FIG. 20, shows an inner stop, here shown as sleeve shaped, according to one embodiment the invention.

### DETAILED DESCRIPTION OF THE PREFERRED EMBODIMENT

Reference will now be made in detail to the present preferred embodiments of the invention as illustrated in the accompanying drawings.

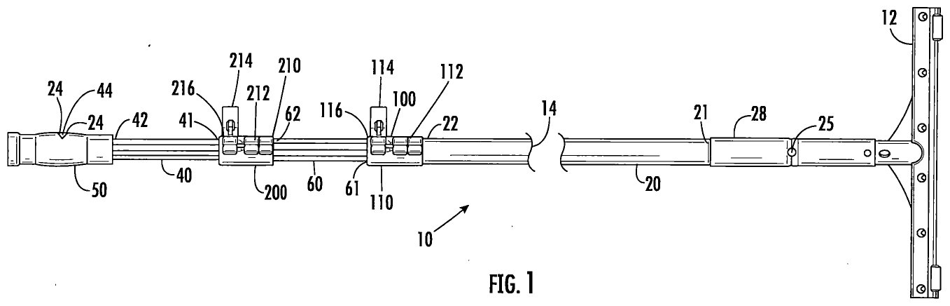

In accordance with the present invention, and as seen in FIG. 1, there is provided in a preferred embodiment of the invention, a telescoping apparatus 10, for cleaning swimming pools, surface cleaning tools, cement finishing tools, ceiling wire applications and the like. In the preferred embodiment the telescoping apparatus 10, includes decagon shaped tubes for preventing the telescoping apparatus from internal twisting while providing enhanced strength and grip, the apparatus is useful for cleaning swimming pools, surface cleaning tools, cement finishing tools, and ceiling wire applications. Preferably, the tubes are composed of carbon or carbon fiber and may be a carbon composite or other durable resilient materials may also be used such as fiberglass, metal, or thermoplastics.

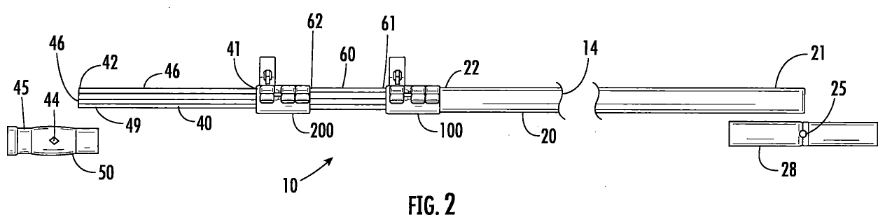

Preferably, a first tube 20, having a first end 21, and a second end 22, the second end 22, having a first locking assembly 100, secured thereto. First tube 20, has a decagon shaped interior surface 14, seen in FIGS. 1 and 2. The first end 21, of first tube 20, is configured for attaching a tool 12, thereto. The first locking assembly 100, includes a locking collar 110. Preferably locking collar 110 has a receiving cradle 112, for a first quick release locking and positioning mechanism 116, and one or more relief channels 118, on the interior of the locking collar for increased locking strength of the collar.

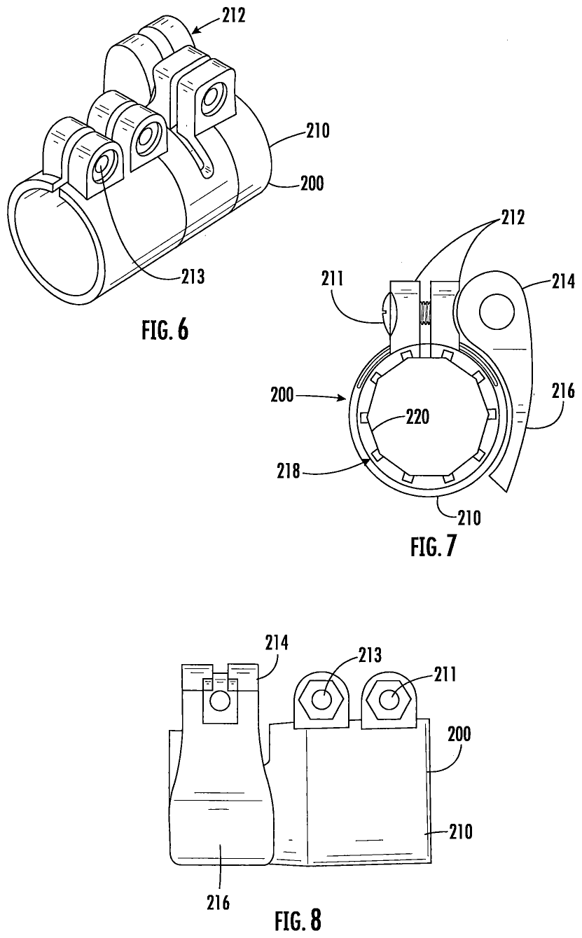

In FIG. 1, according to a preferred embodiment, a decagon shaped end tube 40, has a first end 41, and a second end 42. The first end 41, having a second locking assembly 200. The second locking assembly 200, includes a locking collar 210. Locking collar 210, of the second locking assembly 200, has a receiving cradle 212, for a second quick release locking and positioning mechanism 214, with lever 216, best seen in FIGS. 6 and 7, and one or more relief channels 218, on the interior of the locking collar 210, for increased locking strength of the collar. End tube 40, has an inner decagon shaped surface 44, and an outer decagon shaped surface 46. Second end 42, preferably includes a V-shape clip mechanism 22, best seen in FIG. 11, and a stop ring mechanism 49. V-shape clip 22, preferably with button 24, operably fits into hole 44, on removable hand grip 50, best seen in FIGS. 1 and 2, for securing hand grip 50, thereto and to prevent unwanted movement of the hand grip.

In FIGS. 1 and 2, a decagon shaped inner tube 60, having a first end 61, and a second end 62, with first end 61, being secured to first tube 20, by first locking assembly 100, and second end 62, being secured to end tube 40, by second locking assembly 200. The decagon shaped inner tube is adapted and configured to receive within end tube 40, and accordingly has a larger diameter than end tube 40. Decagon shaped end tube 40, is shaped to slide within the inner tube 60 to a selected position in relation to the inner tube, allowing for said second locking assembly to position and secure the decagon shaped end tube within the inner tube by the second locking assembly.

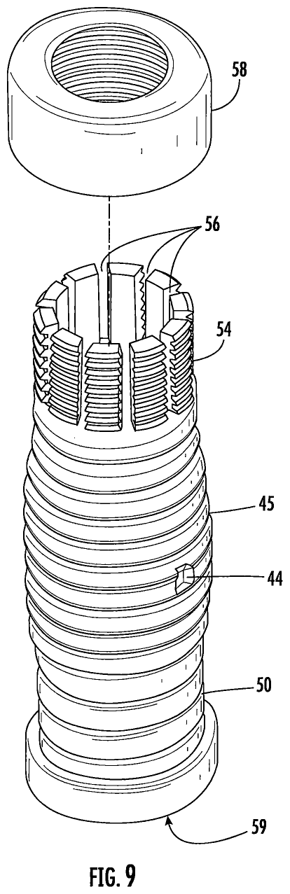

In FIG. 2, telescoping assembly 10, is shown without a tool attached thereto. In FIG. 2, it is seen that decagon shaped end tube 40, slides within decagon shaped inner tube 60, and decagon inner tube 60, slides withing first tube 20, which has a decagon shaped interior surface 14. Accordingly, in the preferred embodiment of the invention, first tube 20, has a larger diameter than inner tube 60, and inner tube 60, has a larger diameter than end tube 40. First locking assembly 100, and second locking assembly 200. Hand grip 50, seen in FIG. 9 with grooves 45, and aperture 44, for receiving a V-shape clip and button 24, which is best seen in FIG. 11, for easy removal or placement of hand grip 50. First tube 20, is shown with sleeve 28, preferably composed of a metal or other durable resistant material, and aperture 25, for button 24, of another V-shape clip 22, best seen in FIG. 11. It is seen that one V-shape clip is used for securing handle 50, and a another V-shape clip is used to secure sleeve 28, and tool 12. Both may be similarly sized, or different.

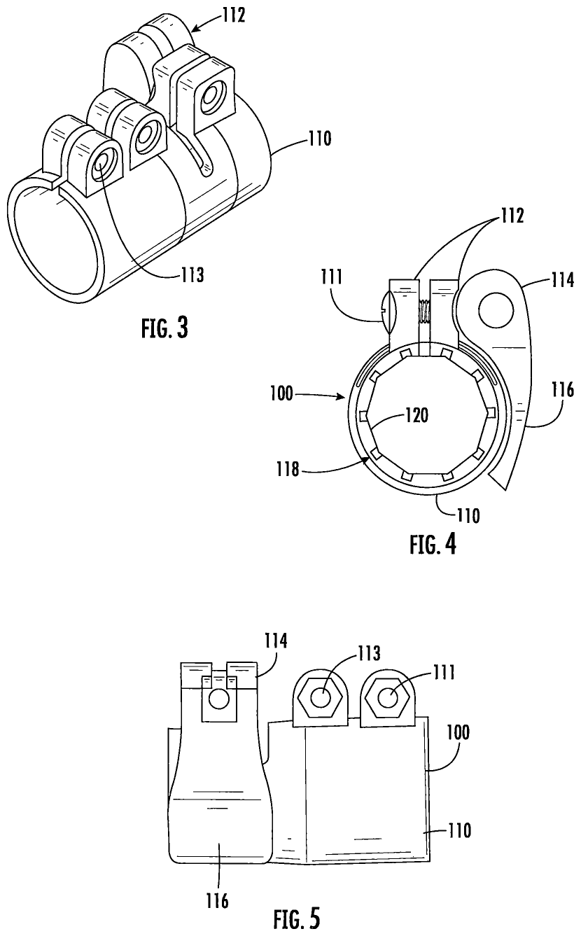

In FIG. 3, locking collar 110, is shown which is part of locking assembly 100, best seen in FIGS. 4 and 5. Locking collar 110, has receiving cradle 112, and apertures 113, which are shown for receiving bolts, screws, clips or other mechanical fastening means.

Referring now to FIG. 4, first locking assembly 100, is shown with receiving cradle 112, and fasteners 111, which may be bolts, nuts, screws, or clips. Locking collar 110, is seen with internal channels 118, and surfaces 120, which engage with inner decagon shaped tube 60. Preferably ten surfaces 120, and ten channels 118 are provided. The locking collar 110, has a levering action that closes the ten surfaces 120, against the ten surfaces on inner tube 60. The ten surfaces 120, being interrupted by channels 118, between each surface allows for more flexibility in the lock for increased tightness. This evenly applies pressure on the outside of inner tube 60, flat surfaces. It is noted, that although locking assembly has been described for use with a decagon shaped tube, if other geometric configurations are used such as six sided or eight sided tubes, for example, the corresponding channels and intervening surfaces would be accordingly reduced to six or eight respectively. By using receiving cradle 112, quick release locking and positioning mechanism 114, with lever arm 116, may be utilized on either side of telescoping apparatus 10.

As seen in FIG. 5, first locking assembly 100, with locking collar 110, is seen with quick release locking and positioning mechanism 114, with lever 116, with receiving apertures 113, for fasteners 111, which may be bolts, nuts, screws, clips, or the like.

In FIGS. 6, 7 and 8, second locking assembly 200, is shown which is sized to accommodate end tube 40, and inner tube 60, and secures end tube 40, to inner tube 60, but is otherwise similar to first locking assembly 100, shown in FIGS. 3-5. In FIG. 6, locking collar 210, of second locking assembly 200, is shown with receiving cradle 212, for quick release locking and positioning mechanism 214, best seen in FIGS. 7 and 8. Receiving apertures 213, are shown for fasteners, which may be bolts, screws, nuts, or clips, 211, seen, for example in FIGS. 7 and 8.

In FIG. 7 locking collar 210, of second locking assembly 200, is shown with receiving cradle 212, for quick release locking and positioning mechanism 214, with lever 216. It is seen that second locking assembly 200, preferably includes ten relief channels 218, on the interior of the locking collar 210, for increased locking strength of the collar, and ten separate flat surfaces 220, to compress to each of the ten surface of the decagon shaped end tube. If tubes having different surface characteristics, such as fours sides, or six sides, or eight sides, and so on, then corresponding relief channels and separate flat surfaces would be matched accordingly with four, six, eight channels and surfaces respectively.

With reference now to FIG. 8, second locking assembly 200, is shown with locking collar 210, with receiving apertures 211, for tightening fasteners 213. Quick release locking and positioning mechanism 214, with lever 216, are also shown.

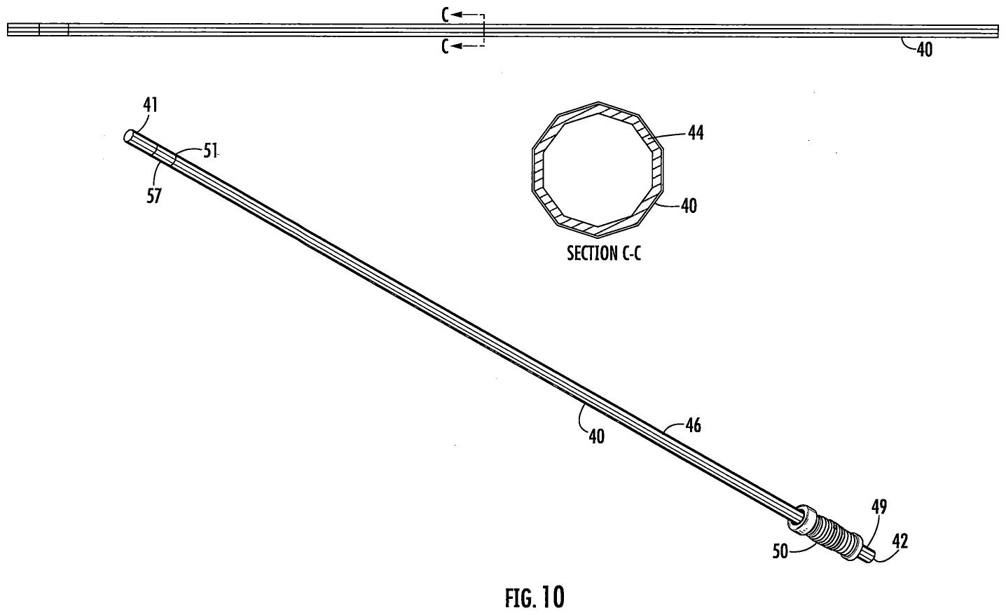

In FIG. 9, a preferred embodiment of hand grip 50, is shown having a a section with a plurality of grooves 45. Hand grip 50, preferably also includes a male threaded section with a plurality of tapered threads 54, on an outside thereof, and a female threaded nut 58, for making a female type lock to the male threaded section. The tapered threaded section includes a plurality of slits 56, to correspond to the decagon shaped surface of end tube 40, and enables the hand grip 50, to be securely tightened and fastened to the end tube. Tapered threads 54, enable the hand grip 50, to be tightened or compressed onto end tube 40, when the female threaded nut 58, is screwed into male threaded section 54, of the hand grip. Receiving aperture 44, in hand grip 50, is shown for positioning of button 24, on V-shape clip 22, best seen in FIG. 11. Preferably, at the bottom of hand grip 50, is an external ring of plastic or other material that is attached to tube 40 to create a stop ring 49, seen in FIG. 10. This eliminates movement on the grip which can cause movement of the V-shape clip which will eventually wear on aperture 44, that receives button 24 of V-clip 22. Under normal conditions of use, the operator will slide the tubes together in a quick motion, placing grip 50, into the locking fittings. Stop ring 49, eliminates unwanted movement when this occurs, seen in FIG. 10.

In FIG. 10, end tube 40, is shown alone for illustrative purposes, having internal stop ring 51, in proximity to first end 41, and hand grip 50, with external stop ring 49. It is noted, that in different embodiments of the invention internal stops may be placed in various positions within tube end 40, and inner tube 20. As seen in FIGS. 1 and 11, by using a V-shape clip 22, with buttons 24, grip 50, will stay secured to end pole 40, and easily changed if the grip wears out. An external ring 49, of hand grip 50, best seen in FIG. 10, which may be an external ring of plastic or other durable resilient material, is used to create a stop ring. This helps eliminate movement of the grip which can cause movement on the V-shape clip, which will eventually create wear aperture 44 which receives the V-shape clip. Under normal use the operator will slide the three tubes, first tube 20, inner tube 60, and end tube 40 together in a quick motion, positioning the grip on end tube 40. External stop ring 49, eliminates unwanted movement when this occurs. Hand grip 50, may also be attached by slitting a short section of the end of the grip, so that slits 56, correspond to the tube shape, such as ten, eight, six, and the like, depending upon the configuration of the tube used.

When using materials such as carbon fiber or fiberglass, first tube 20, is best reinforced at the end securing a tool with a sleeve 28, of a durable resilient material, such aluminum, steel, stainless steel or other metal. As seen in FIG. 1, first end 21, of first tube 20, has sleeve 28, and tool 12 secured thereto. Sleeve 28, may be secured to first tube 20, by being pressed tightly and and form fitted thereto, or by adhesives, epoxy, or mechanical fastening means such as clips, screws, or bolts.

In FIG. 12, sleeve 28, is shown detached from telescoping apparatus 10, for illustrative purposes, having receiver aperture 25, for V-shape clip 22, with button 24, best seen in FIG. 11. By using a V-shape clip or bolt through the inside side of first tube 20, and into sleeve 28, the sleeve can be easily changed if worn out or damaged.

In some applications, and according to other preferred embodiments of the invention a magnet 30, best seen in FIG. 13 with housing 31, with a post 32, which is preferably mushroom otherwise, such as shaped, but may be rectangular, round, square and the like. Magnet housing 31, is preferably composed of a plastic or other nonferrous material. By having a magnet encased in a protective housing that has a mushroom shaped post 32, at one end, the tip will snap into an aperture or hole 59, at end of grip 50, and also found in standard hand grips, allowing for easy installation or replacement.

Preferably, first tube 20, end tube 40, and inner tube 60, are composed of carbon fiber, fiberglass, or carbon composite, however, other durable, resilient materials may be used if desired. In the preferred embodiment first tube 20, end tube 40, and inner tube 60 are composed of carbon fiber.

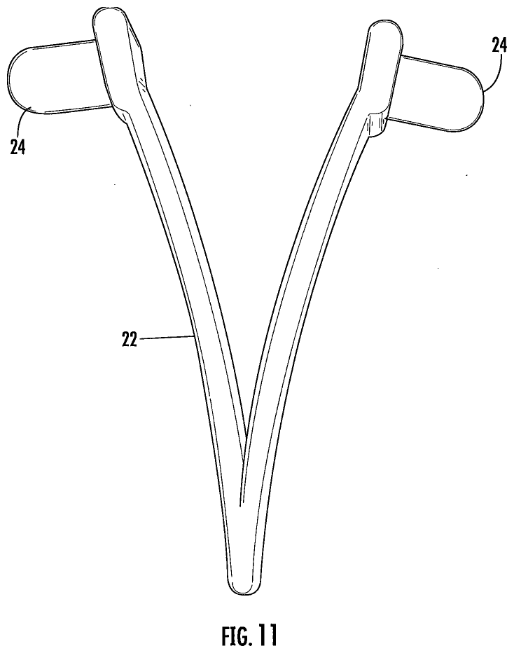

With reference now to FIG. 14, first tube 20, inner tube 60, and end tube 40, are shown side by side without the grip, locking assemblies, or tool, for illustrative purposes. As discussed above, preferably tubes 40, and 60, have decagon shaped surfaces, and tube 20 has an inner decagon shaped surface. However, in alternative embodiments, other geometric configurations may be used, such as, hexagon shaped, octagon shaped, dodecagon shaped, and the like, as alternative polygons to the preferred decagon shaped configurations. In FIG. 14 internal stops 51, on tube 40, and internal stop 65, on tube 60, are also shown. First tube 20, may also include an inner stop 222, seen in FIG. 20, which may be sleeve shaped or otherwise, for preventing unwanted movement of the end tube and the inner tube.

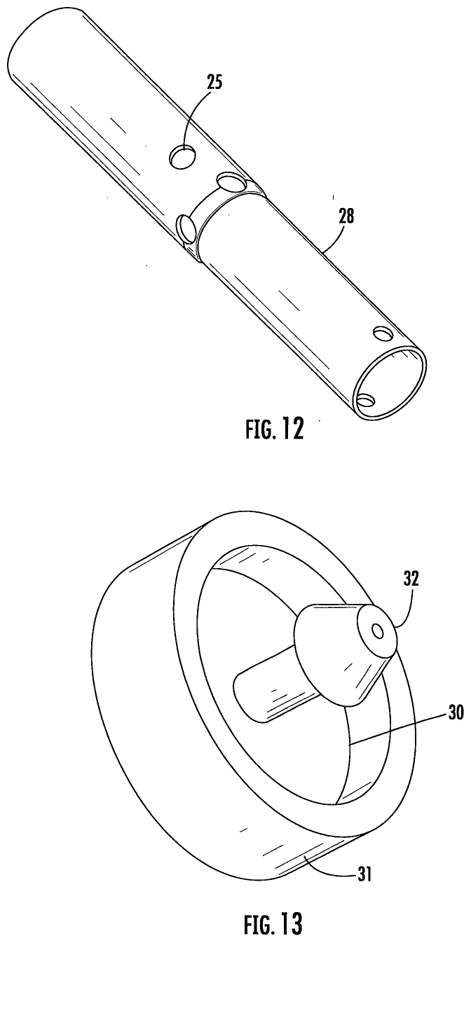

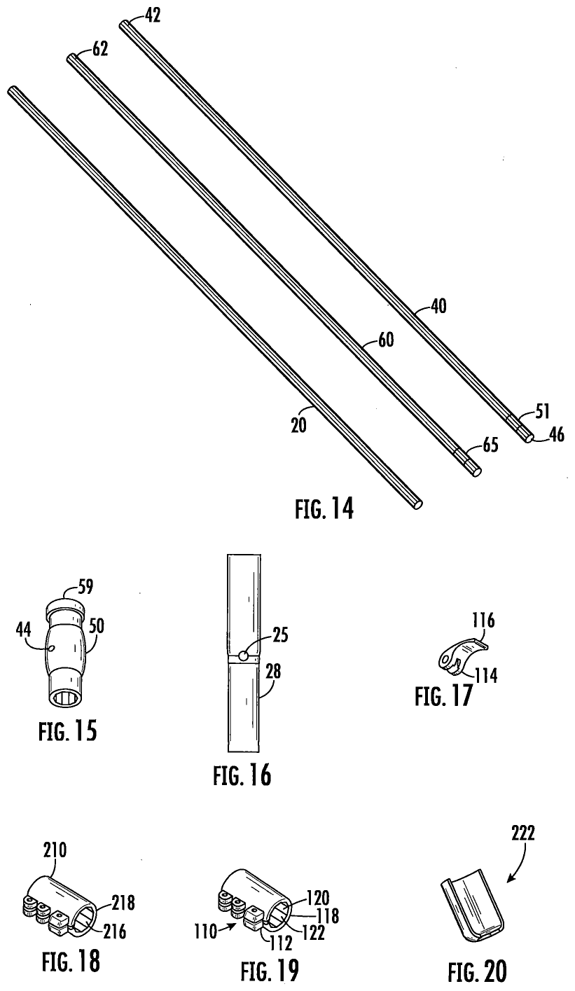

In FIG. 15, another embodiment of grip 50 is shown with aperture 44, for button of a V-shape clip 22. This is an alternative embodiment of grip 50, shown in FIG. 9. In FIG. 16, sleeve 28 is shown detached from telescoping apparatus 10, with aperture 25, for button of V-shape clip 22. FIG. 17, shows lever 116, of first quick release 114, detached from locking assembly 100.

For illustrative purposes, FIG. 18 shows locking collar 210, and FIG. 19 shows locking collar 110, detached from telescoping apparatus 10, and without levers 216, and 116, respectively. It is seen that locking collar 110 is sized to secure first tube 20, to inner tube 60, and locking collar 210, is sized to secure end tube 40, to inner tube 60, at at second end 62, of inner tube 60.

In operation and use, the telescoping apparatus 10, of the present invention provides an apparatus that may be used for a variety of purposes, with different tools that can be secured to telescoping apparatus depending upon the use and application. In particular, telescoping apparatus 10, provides an apparatus for attachment to tools for cleaning swimming pools, surface cleaning tools, cement finishing tools, ceiling wire tools, or the like. Telescoping apparatus 10, may be easy, safely, and efficiently used to extend the reach of the user while using the tool. Telescoping apparatus 10, easily and quickly snaps or locks into place by using a locking assemblies 100, and 200. Unwanted slippage and twisting is prevented during heavy use and pressure by use of the quick release assemblies with lever locks 114, and 214, which can be tightened against the decagon shaped surfaces, or alternatively other surfaces such as six sided, eight sided, and the like, so as to provide a flat surface as distinct from a round surface found in conventional telescoping apparatuses and poles. This allows the lever lock to have increased locking and tightening effect, and provides increased locking of collars 110, and 210. Relief channels 118, and 218, provide for increased locking tightness of locking assemblies 100 and 200, respectively. Telescoping pole or apparatus 10, may be used for pool cleaning, surface cleaning, cement finishing, ceiling wire applications and any application that requires different lengths of a pole or tubing at different times of application. Telescoping apparatus 10, may be provided in a wide variety of different sizes and configurations, and tubes 20, 40, and 60 are preferably composed of a carbon fiber or other carbon composite.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A telescoping apparatus including decagon shaped tubes for preventing the telescoping apparatus from internal twisting while providing enhanced strength and grip, the apparatus is useful for cleaning swimming pools, surface cleaning tools, cement finishing tools, and ceiling wire applications, comprising:
a first tube having a first end and a second end, said second end having a first locking assembly; said first tube having a decagon shaped interior surface, and said first end of said first tube being configured for attaching a tool thereto, said first locking assembly includes a locking collar; said locking collar having a receiving cradle for a first quick release locking and positioning mechanism, and one or more relief channels on the interior of the locking collar for increased locking strength of the collar;
a decagon shaped end tube having a first end and a second end; said first end having a second locking assembly, said second locking assembly includes a locking collar; said locking collar of said second locking assembly having a receiving cradle for a second quick release locking and positioning mechanism, and one or more relief channels on the interior of the locking collar for increased locking strength of the collar; said end tube has an inner decagon shaped surface and an outer decagon shaped surface, and a second end with a clip mechanism and a stop ring mechanism for securing a removable hand grip thereto and to prevent unwanted movement of the hand grip; and
a decagon shaped inner tube having a first end and a second end, said first end being secured to said first tube by said first locking assembly, and said second end being secured to said end tube by said second locking assembly; said decagon shaped inner tube is adapted and configured to receive the end tube therein; the decagon shaped end tube is shaped to slide within the inner tube to a selected position in relation to the end tube, allowing for said second locking assembly to position and secure the decagon shaped end tube within the inner tube by the second locking assembly.

2. The telescoping apparatus of claim 1, wherein said locking collar of said first locking assembly with said receiving cradle for said first quick release locking and positioning mechanism, and includes ten relief channels on the interior of the locking collar for increased locking strength of the collar, and ten separate flat surfaces to compress to each of the ten surfaces of the decagon shaped inner tube.

3. The telescoping apparatus of claim 1, wherein said locking collar of said second locking assembly has said receiving cradle for said first quick release locking and positioning mechanism, and includes ten relief channels on the interior of the locking collar for increased locking strength of the collar, and ten separate flat surfaces to compress to each of the ten surface of the decagon shaped end tube.

4. The telescoping apparatus of claim 1, wherein said clip mechanism includes a V-shape clip to insert through the inside of said end tube, and an external stop ring mechanism for securing a removable hand grip thereto and to prevent unwanted movement of the hand grip.

5. The telescoping apparatus of claim 1, wherein a sleeve is secured to said first tube to receive and secure a tool 1 thereto.

6. The telescoping apparatus of claim 5, wherein said sleeve is secured by a V-shape clip.

7. The telescoping apparatus of claim 1, wherein said hand grip includes a section having a plurality of grooves along a bottom surface thereof; said hand grip also includes a male threaded section with a plurality of tapered threads on an outside thereof, and a female threaded nut for making a female type lock to said male threaded section; said tapered threaded section includes a plurality of slits to correspond to said decagon shaped surface of said end tube, and enables the hand grip to be securely tightened and fastened to the end tube; said tapered threads enable the hand grip to be tightened or compressed onto said end tube when said female threaded nut is screwed into said male threaded section of said the hand grip.

8. The telescoping apparatus of claim 1, wherein a magnet is positioned and secured at said second end of said end tube, said magnet being cased in a protective housing.

9. The telescoping apparatus of claim 1, wherein said first tube, said inner tube, and said end tube are composed of carbon fiber.

10. A carbon fiber telescoping apparatus including decagon shaped tubes for preventing the telescoping apparatus from internal twisting while providing enhanced strength and grip, comprising:
a first tube having a first end and a second end, said second end having a first locking assembly; said first tube having a decagon shaped interior surface, and said first end of said first tube being configured for attaching a tool thereto; said first locking assembly includes a locking collar; said locking collar having a receiving cradle for a first lever quick release locking and positioning mechanism, and ten relief channels on the interior of the locking collar for increased locking strength of the collar, and ten separate flat surfaces to compress to each of the ten surfaces of the decagon shaped inner tube for increased locking strength of the collar;
a decagon shaped end tube having a first end and a second end; said first end having a second locking assembly, said second locking assembly includes a locking collar; said locking collar of said second locking assembly having a receiving cradle for a second quick release locking and positioning mechanism, and ten relief channels on the interior of the locking collar and and ten separate flat surfaces to compress to each of the ten surfaces of the decagon shaped end tube, for increased locking strength of the collar; said end tube have an inner decagon shaped surface and an outer decagon shaped surface, and a second end with a clip mechanism and a stop ring mechanism for securing a removable hand grip thereto and to prevent unwanted movement of the hand grip; and
a decagon shaped inner tube having a first end and a second end, said first end being secured to said first tube by said first locking assembly, and said second end being secured to said end tube by said second locking assembly; said decagon shaped inner tube is adapted and configured to receive said end tube therein; the decagon shaped end tube is shaped to slide within the inner tube to a selected position in relation to the inner tube, allowing for said second locking assembly to position and secure the decagon shaped end tube within the inner tube by the second locking assembly.

11. The carbon fiber telescoping apparatus of claim 10, wherein said clip mechanism includes a V-shape clip to insert through the inside of said end tube, and an external stop ring mechanism for securing a removable hand grip thereto and to prevent unwanted movement of the hand grip.

12. The carbon fiber telescoping apparatus of claim 10, wherein a sleeve is secured to said first tube to receive and secure a tool thereto.

13. The telescoping apparatus of claim 10, wherein said sleeve is secured by a V-shape clip.

14. The telescoping apparatus of claim 10, wherein said hand grip includes a section having a plurality of grooves along a bottom surface thereof; said section of said hand grip having the plurality of grooves includes a plurality of tapered threads on an outside of said section having the plurality of grooves, making a female section or a male to female type lock; said tapered threads enable the hand grip to be tightened or compressed onto said end tube when a mechanical fastener is screwed into a male section of said section of said hand grip having the plurality of grooves.

15. The telescoping apparatus of claim 10, wherein a magnet is positioned and secured at said second end of said end tube, said magnet being cased in a protective housing.

16. The telescoping apparatus of claim 10, wherein said first tube, said inner tube, and said end tube are composed of a carbon composite.

17. A carbon fiber composite telescoping apparatus including decagon shaped tubes for preventing the telescoping apparatus from internal twisting while providing enhanced strength and grip, comprising:
a first tube having a first end and a second end, said second end having a first locking assembly; said first tube having a decagon shaped interior surface; said first end of said first tube being configured for attaching a tool thereto, said first locking assembly includes a locking collar; said locking collar having a receiving cradle for a first lever quick release locking and positioning mechanism, and ten relief channels on the interior of the locking collar for increased locking strength of the collar, and ten separate flat surfaces to compress to each of the ten surfaces of the decagon shaped inner tube one or more relief channels on the interior of the locking collar for increased locking strength of the collar; the first tube includes a sleeve secured to the first tube to receive and secure a tool thereto;
a decagon shaped end tube having a first end and a second end; said first end having a second locking assembly, said second locking assembly includes a locking collar; said locking collar of said second locking assembly having a receiving cradle for a second quick release locking and positioning mechanism, and ten relief channels on the interior of the locking collar and and ten separate flat surfaces to compress to each of the ten surfaces of the decagon shaped end tube, for increased locking strength of the collar; said end tube have an inner decagon shaped surface and an outer decagon shaped surface, and a second end with a clip mechanism and a stop ring mechanism for securing a removable hand grip thereto and to prevent unwanted movement of the hand grip, said clip mechanism includes a V-shape clip to insert through the inside of said end tube, and an external stop ring mechanism for securing a removable hand grip thereto and to prevent unwanted movement of the hand grip; and
a decagon shaped inner tube having a first end and a second end, said first end being secured to said first tube by said first locking assembly, and said second end being secured to said end tube by said second locking assembly; said decagon shaped inner tube is adapted and configured to receive said end tube; the decagon shaped end tube is shaped to slide within the inner tube to a selected position in relation to the inner tube, allowing for said second locking assembly to position and secure the decagon shaped end tube within the inner tube by the second locking assembly.

18. The telescoping apparatus of claim 17, wherein said sleeve secured to said first tube is secured by a V-shape clip.

19. The telescoping apparatus of claim 17, wherein a magnet is positioned and secured to said end tube, said magnet being cased in a protective housing.

20. The telescoping apparatus of claim 17, wherein said first tube includes at least one inner stop for preventing unwanted movement of said decagon shaped end tube and said inner tube.
